(19) United States
(12) Patent Application Publication
(10) Pub. No.: US 2021/0158375 A1
(43) Pub. Date: May 27, 2021

(54) SYSTEM AND METHOD FOR CREATING A TRADING STRATEGY

(71) Applicant: Umesh Ranglani, MUMBAI (IN)

(72) Inventor: Umesh Ranglani, MUMBAI (IN)

(21) Appl. No.: 16/697,640

(22) Filed: Nov. 27, 2019

(51) Int. Cl. G06Q 30/02; H04W 4/029; G06F 16/9535; H04L 29/08

(52) U.S. Cl. CPC G06Q 30/02; H04W 4/029; H04L 67/306; H04L 67/18; G06F 16/9535

(57) ABSTRACT

System and method for creating a trading strategy are disclosed. The method includes connecting one or more databases associated with corresponding multiple exchanges, enabling a user to create a strategy, selecting one or more keywords from a plurality of keywords by using a point and click option, setting up one or more conditions from a plurality of pre-defined conditions corresponding to one or more selected keywords using the point and click option, setting up one or more parameters associated with the corresponding one or more conditions based on the one or more selected keywords using the point and click option and positioning the one or more conditions to corresponding one or more legs for creating a positioning map using a positioning technique, wherein the positioning map is representative of the trading strategy.

### FIELD OF INVENTION

Embodiments of a present invention relate to financial market and security exchange, and more particularly to a system and method for creating a trading strategy for making transactions in financial securities.

### BACKGROUND

A financial market is a market in which people trade financial securities and derivatives at low transaction costs using different strategies. In a conventional approach, the trading strategies are done manually by one or more parties who include buyers and sellers by using available data or parameters associated with corresponding financial securities.

In comparison to the conventional approach, a newer approach uses a semi-automatic platform to create strategies to support the financial securities. Such system requires writing a huge code in any of learnt software languages. Such a limitations makes the newer approach time consuming and lethargic. In addition, as every strategy is created upon writing the codes, it is prone to huge mistakes which makes the system less reliable and less user friendly. Also, limiting the usage of the platform from a user who is unaware of writing the codes. Further, the system provides an option of Drag and Drop of Blocks where the user has to drag and drop blocks and set the relation between them to set conditions for signal generation of the trading strategy. In addition, such approach also has a limitation on selecting the number of positions attached to the selected conditions.

Hence, there is a need for an improved system and method for creating a trading strategy to address the aforementioned issues.

### BRIEF DESCRIPTION

In accordance with one embodiment of the disclosure, a method for creating a trading strategy is provided. The method includes connecting one or more databases associated with corresponding multiple exchanges. The method also includes enabling a user to create a strategy. The method also includes selecting one or more keywords from a plurality of keywords by using a point and click option. The method also includes setting up one or more conditions from a plurality of pre-defined conditions corresponding to one or more selected keywords using the point and click option. The method also includes setting up one or more parameters associated with the corresponding one or more conditions based on the one or more selected keywords using the point and click option. The method also includes positioning the one or more conditions to corresponding one or more legs for creating a positioning map using a positioning technique, wherein the positioning map is representative of the trading strategy.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a flow chart representing steps involved in a method for creating a trading strategy in accordance with an embodiment of the present disclosure;

FIG. 2 is a schematic representation of a workflow representing working of trading strategy of FIG. 1 in accordance with an embodiment of the present disclosure;

FIG. 3 is a schematic representation of an interface representing creation of trading strategy comprising entry and overnight protection features of FIG. 1 in accordance with an embodiment of the present disclosure;

FIG. 4 is a schematic representation of an interface representing creation of trading strategy comprising a plurality of marketplace features of FIG. 1 in accordance with an embodiment of the present disclosure;

FIG. 5 is a schematic representation of an interface representing options associated with conditions and position mapping of FIG. 1 in accordance with an embodiment of the present disclosure; and

FIG. 6 is a block diagram of a system to create a trading strategy in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises... a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to system and method for creating a trading strategy are disclosed. The method includes connecting one or more databases associated with corresponding multiple exchanges. The method also includes enabling a user to create a strategy. The method also includes selecting one or more keywords from a plurality of keywords by using a point and click option. The method also includes setting up one or more conditions from a plurality of pre-defined conditions corresponding to one or more selected keywords using the point and click option. The method also includes setting up one or more parameters associated with the corresponding one or more conditions based on the one or more selected keywords using the point and click option. The method also includes positioning the one or more conditions to corresponding one or more legs for creating a positioning map using a positioning technique, wherein the positioning map is representative of the trading strategy.

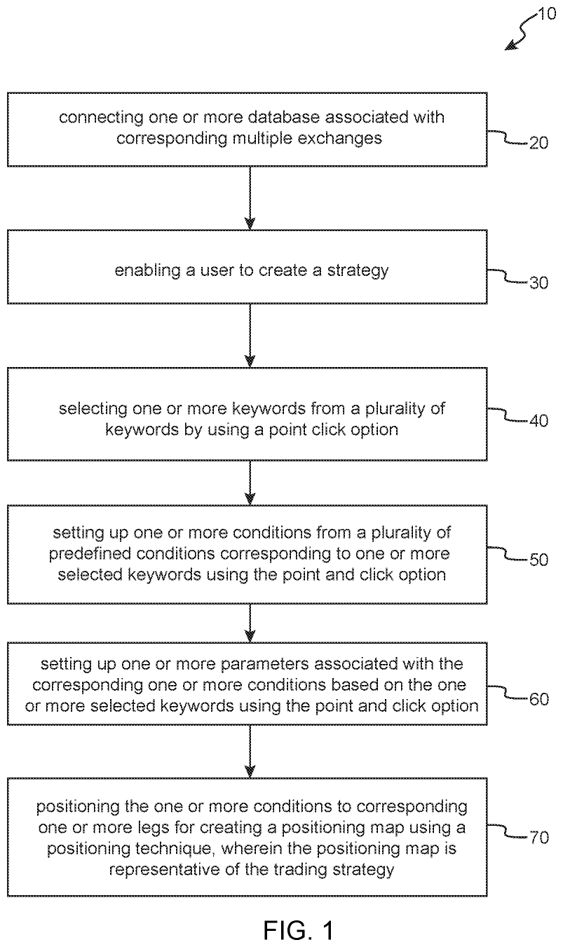

FIG. 1 is a flow chart representing steps involved in a method 10 for creating a trading strategy in accordance with an embodiment of the present disclosure. As used herein, the term “trading strategy” is defined as a fixed plan or a fixed strategy that is designed to achieve a profitable return by going long or short in markets. In one preferred embodiment, the trading strategy is associated to algo strategy. As used herein, the term “algo strategy” also known as algorithmic strategy is defined as a method of executing orders using automated pre-programmed trading instructions accounting for variables, wherein the variables may include time, price, and volume. In one preferred embodiment, the trading strategy may be created to keep of track of trading process associated to financial markets more particularly to foreign financial markets.

The method 10 includes connecting one or more databases associated with corresponding multiple exchanges in step 20. In one embodiment, the multiple exchanges may be associated with multi asset, multi-currency, multi exchange and the like. Henceforth, the one or more databases are associated with the corresponding multiple exchanges. In one specific embodiment, the one or more databases may be associated with real-time data representative of price value of product or services in a standardised marketplace.

The method 10 also includes enabling a user to create a strategy in step 30. In one embodiment, the user may create the trading strategy rules for instruments across multiple exchanges and enter and exit positions as defined by those rules. In another embodiment, the user may allow other users to buy and sell the already built trading strategies for a fixed fee, a variable fee or for free.

Creating the trading strategy includes selecting one or more keywords from a plurality of keywords by using a point and click option in step 40. In one embodiment, the one or more keyword may include one of Price Data, Date Time, Event, Technical, Option Greeks, Runtime Variables, Strategy Info, Maths, Statistics, FX_Rates, and the like.

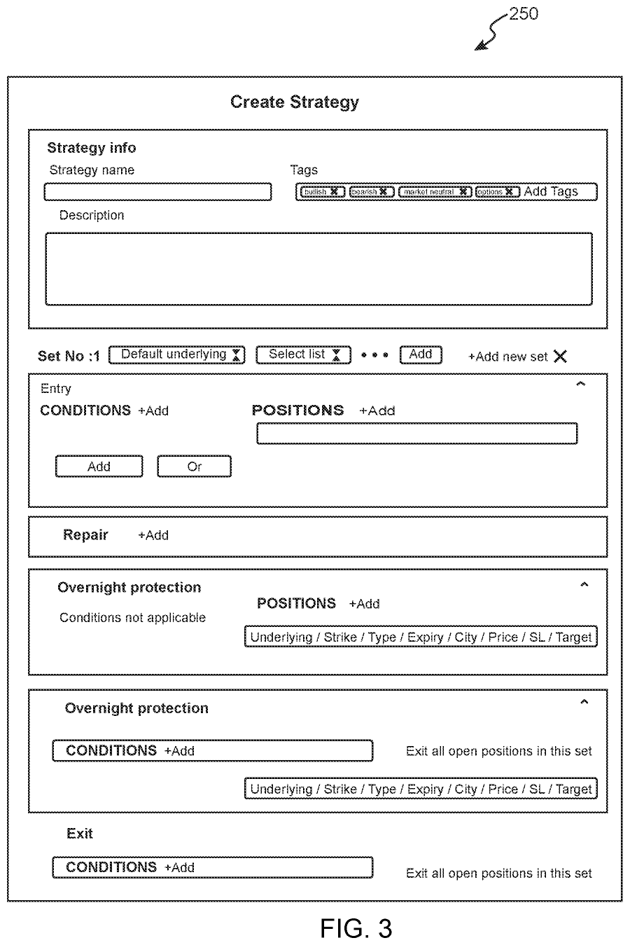

Furthermore, the method 10 includes setting up one or more conditions from a plurality of pre-defined conditions corresponding to one or more selected keywords using the point and click option in step 50. In one embodiment, plurality of pre-defined conditions may include AND, OR, and the like (as shown in FIG. 3) 250. In such embodiment, the one or more conditions may be selecting upon pointing on pre-defined condition and clicking on the required conditions. In one exemplary embodiment, the one or more conditions may be added by the user based on the selected keywords. As used herein, the term “condition” is referred to a “condition mapping technique” which is defined as a technique which lets the user to specify that data in a transformation is mapped based on a defined condition. Also, the applied condition determines if the data is mapped.

The method 10 also includes setting up one or more parameters associated with the corresponding one or more conditions based on the one or more selected keywords using the point and click option in step 60. In one embodiment, the one or more parameters may be related to currency more particularly to foreign exchange currency. In such embodiment, the one or more parameters may be selected to determine historical performance of the trading strategy.

The method 10 also includes positioning the one or more conditions to corresponding one or more legs for creating a positioning map using a positioning technique, wherein the positioning map is representative of the trading strategy in step 70. As used herein, the term “positioning” also referred to as “positioning mapping” is defined as a technique or a strategy which allows an entity to spotlight specific areas where they can outshine and beat their competition with respect to the ongoing market. In one embodiment, creating the positioning map comprises creating the positioning map on a web-based strategy building platform.

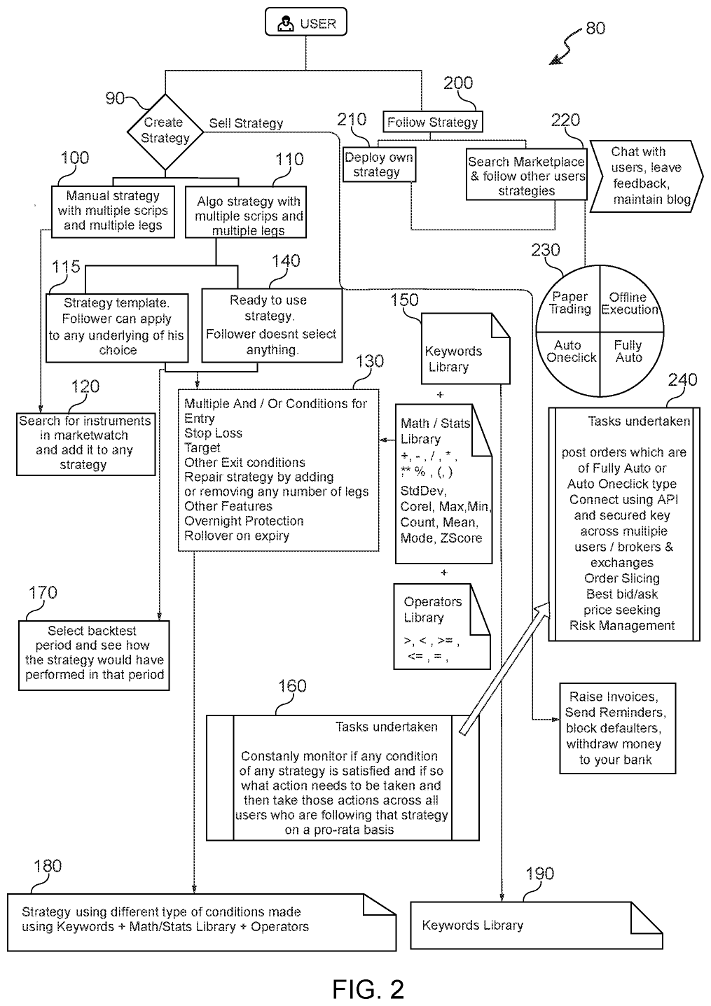

In one exemplary embodiment (as shown in FIG. 2), the trading strategy may be created as described hereafter in step 90. The method 80 may include manual strategy creation with multiple scrips and multiple legs in step 100. Further one or more instruments may be searched from a market watch and is added to the corresponding one or more strategies in step 120. The method 80 may also include creating algo strategy with multiple scrips and multiple legs in step 110. In such a method creating the algo strategy may be automated.

In such a method 80, the user may apply any conditions, keywords and positions of the user's choice to create the trading strategy template in step 115. In such another embodiment, the user may use an already existing/ created strategy template (as shown in FIG. 2) in step 140.

Referring back to the above-mentioned embodiment, upon selection of the trading strategy template, one or more conditions are selected by the user based on the keywords (in step 130) such as entry, stop loss, target, Other Exit conditions, Repair strategy by adding or removing any number of legs, Other Features - Overnight Protection (as shown in FIG. 3) 250, Rollover on expiry, and/ or the like. In addition, the one or more keywords may be selected by a plurality of keyword libraries which may include maths/ stats library, operator library, and the like in step 150. For example, the plurality of keyword libraries may include in step 190:
a. Price Data: Open, High, Low, Close, Volume, CMP, BID, ASK;
b. Date Time: Now, Curr Expiry, Next Expiry, Result Date, Last Trade Date Time;
c. Technical: SMA, EMA, WMA, Parabolic Sar, Upper Bolinger, Lower Bolinger, RSI, MACD, Supertrend, Williams % R, ADX, AroonUp, AroonDown;
d. Option Greeks: Delta, Gamma, Theta, Vega, IV, HV;
e. Strategy: ROI, Total Value of A Position, Days Since Start, Base, All State

Variables, Count Lots, Count Trades, Margin Used, Total Exposure of A Position.

Furthermore, based on the selected conditions, keyword and the plurality of keyword libraries in step 180. For example:

a. Simple Entry condition to enter based on price
IF CMP(AAPL)<1200 THEN Positions:
AAPL Futures Sept18 |+500.

b. Technical analysis based entry into covered call
IF EMA,20 (Scrip)>EMA,200 (Scrip) THEN Positions:
Scrip Cash |+2 Lots
Scrip Calls |CurrMonth ATMStrike+200|−2 Lots

c. Exit condition for Target and Stop Loss
IF ROI (Strategy)>2% OR
IF ROI (Strategy)<−1% THEN Exit All Positions

d. Repair condition to move short calls by 100 points
IF CMP(Scrip)>Entry Price (Scrip)+200 THEN Positions:
Scrip Calls |CurrMonth ATMStrike+200|+2 Lots
Scrip Calls |CurrMonth ATMStrike+300|−2 Lots

e. Gamma Scalping Strategy using Option Greeks
Entry Conditions
IF IV(Scrip)<30% THEN
Scrip Calls |CurrMonth ATMStrike |+20 Lots
Scrip Puts |CurrMonth ATMStriek |+20 Lots

f. Repair Condition
IF Delta(Strategy)>=150 OR
IF Delta(Strategy)<=−150 THEN Positions:
Scrip Futures CurrMonth |Delta(Strategy)*−1

g. Pair Trading Strategy entry condition
IF CMP(AAPL)/CMP(GOOGL)<0.9 THEN Positions:
AAPL Futures Sept18 Value Of Position(200000)
GOOGL Futures Sept18 Value Of Position(200000)*−1

h. Exit Condition based on proximity to result date
IF Now( )>Result Date(AAPL) −2 OR
IF Now( )>Result Date(GOOGL) −2 THEN Exit All Positions.

Furthermore, the method 80 may include monitoring the trading strategy upon deploying on a user device continuously in real-time upon selection of back test period to see how the strategy would have performed in that period in step 170. In such embodiments, deploying the trading strategy on the user device comprises deploying the trading strategy on one of a paper trading platform or an on-going live platform associated with the user device. As used herein, the term “legs” in the trading strategy is defined as professional options trading jargon for the number of option types that make up an options strategy. More specifically, the leg is defined as a one component of a derivatives trading strategy in which a trader combines multiple options contracts, futures contracts or in rare cases combinations of both to hedge a position, benefit from arbitrage or profit from a spread.

In one exemplary embodiment, the method 80 may further include generating a notification in real time by implementing the trading strategy on a trading platform upon monitoring one or more data associated with the corresponding one or more parameters, wherein the notification is associated to events on the trading platform in real-time.

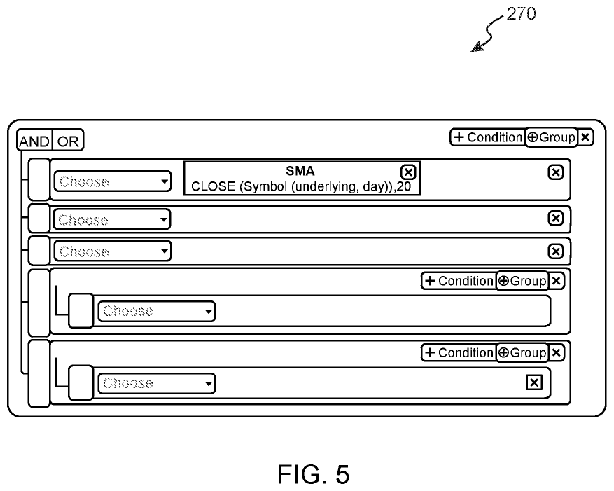

Furthermore, the created trading strategy comprises creating the positioning map on a web-based strategy building platform 270 (as shown in FIG. 5). More specifically, building/ creating a centralised framework. In such embodiment, the tasks undertaken may include constantly monitor if any condition of any strategy is satisfied and if so, what action needs to be taken and then take those actions across all users who are following that strategy on a pro-rata basis in step 160.

In one specific embodiment, the user may use the already built strategy which may be deployed by the user or may search a marketplace and may follow other user's strategy in step 200, 210 and 220. In such embodiment, the trading strategy may include one of paper trading, offline execution, auto one-click and fully automatic strategies in step 230. In such embodiment, the method may further include undertaking tasks such as post orders which are of Fully Auto or Auto One-click type Connect using API and secured key across multiple users/brokers & exchanges Order Slicing Best bid/ask price seeking Risk Management in step 240. Furthermore, paper trading may be simulated trading which allows investors to buy and sell securities without risking real money. Also, in offline execution the strategy is ready to take a trade and may be reached out to the user using a wide gamut of communication methods such as e-mail, SMS, voice call, or the like. And then leave the rest to the user to take forward in whatever manner the user prefers are comfortable with. In such embodiment, the user may be a customer, and/ or a broker.

Also, in auto one-click condition, strategy execution is fairly simple. Assuming the user uses an order management algo software, the customer needs to just link the user account to execute the trades in user strategies automatically. Of course, the users are in control every step of the way and can choose to execute these trades only after you give a one-click confirmation. As per your communication preference, the user will be notified. In addition, in fully automatic strategy, the strategy is pretty much the same as a one-click confirmation. With one major exception. The created trading strategy will be executed automatically without seeking any confirmation from the user.

In one exemplary embodiment, the method may further include generating invoices to their followers based on a fixed, variable fee based on the profits generated by the trading strategy. In another exemplary embodiment, the method may further include enabling the user to do a scenario analysis on any of their strategies using options payoff charts and other scenario analysis tools. Once closed, it provides for a powerful analytical engine to find meaningful information through the reports.

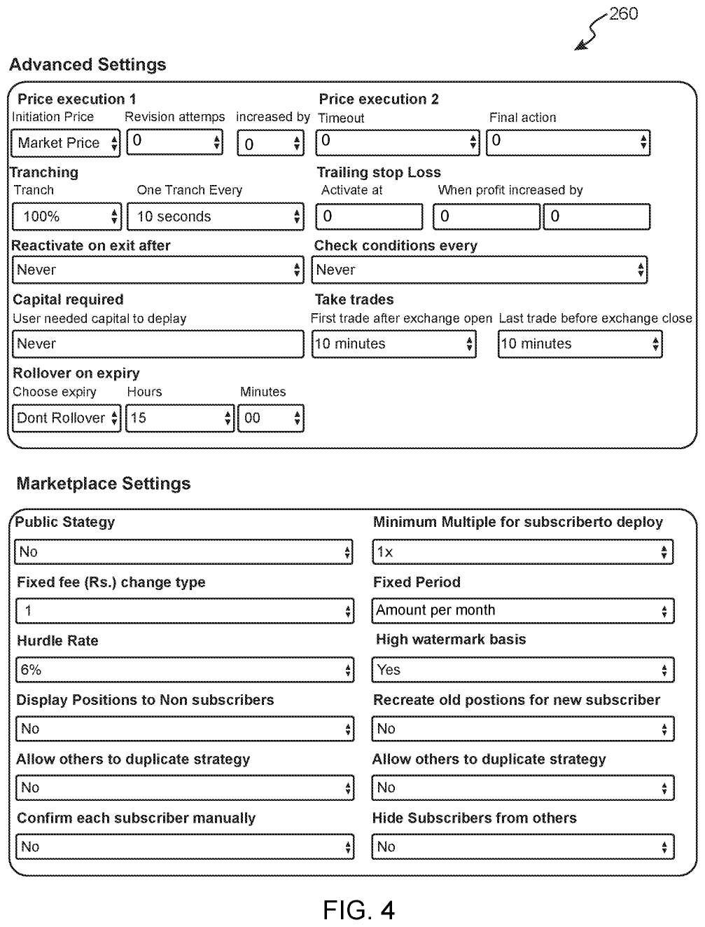

In operation with an example, the framework allows the user to split multiple lots and multi leg order into various tranches so that the user can get the best price with the least slippage. To do that the total order the user can setup in the framework dropdown which by default is at 100% meaning the total quantity is pushed at one go (as shown in FIG. 4) 260. If the user wishes to send it in 2 tranches, the user needs to set the dropdown to 50%; 10% for 10 tranches, 1% for 100 tranches. If there is only 1 leg and the quantity is more than enough for each tranche, it will be equally divided. Further, the remainder of the lots is handled in the last tranche. So, for example there are 21 lots and 10 tranches, the engine will post 2 lots in each tranche and the balance 1 lot is handled in the 11th tranche. If the number of lots are lesser than the tranches then it will get completed with the least no of lots per tranche possible. So, if there are 3 lots and 10 tranches it will get executed in 3 tranches of 1 lot each. If there are multiple legs with differing quantities then the one with the least quantity will get finished before the last tranche is fully executed. So for example, for leg 1 the quantity is 21 lots and for leg 2 is 5 lots so from tranche 1 to 5 the order will be for 2 lots of leg 1 and 1 lot of leg 2 ; from tranche 5 to 10 the order will be 2 lots of leg 1 and the 11th tranche will be 1 lot of leg 1.

In such an embodiment, the execution of the created trading strategy may happen as explained below: There are 5 fields that the user can use to setup the price execution logic:

1) Initiation price 2) Revision attempts 3) Increase by tick 4) Timeout and 5) Final Action. In the Initiation price options are a) Avg of Bid and Ask b) Best Price 3) Market Price 4) LTP. Further if Avg of Bid and Ask price is chosen, for each leg and each tranche, the trading engine will fetch the ask and bid price in real time, calculate the avg of both and submit a limit order at that price; with Best price, for all buy orders the best bid price will be used as the limit price and for sell orders the best ask price will be used; for Market price, for all buy orders the ask price will be used as limit price and for sell orders the bid price will be used so that it can instantly match and the order go through; for LTP, the LTP will be used as Limit price. At no point, 0 will be submitted as the order price due to the various inherent risks involved in such a trading strategy.

Furthermore, Once the initial price has been submitted, now the engine will look at revising the price with the goal of getting the order filled. The user can set this no of attempts in the 2nd setting. During each revision, the price should get closer to getting filled by how many ticks can be mentioned in the 3rd setting. Between each revision how much time should elapse for a timeout can be mentioned in the 4th setting and finally if after all revisions, the order is not filled what should be the final action—should the order be filled at market price or be cancelled can be setup in the 5th setting.

In one exemplary embodiment, working of trailing stop loss may be described as follows: There are 3 settings you can use to setup the Trailing Stop loss feature on the created trading strategy. Activate allows the user to set the absolute amount of money the strategy should be in profit for the TSL to get activated. At this level the TSL will set to 0 which means if the profit falls back to 0, the strategy will exit and the user will not end up in a loss at-least. As the profit increases and goes in favour of the created strategy, the user want to trail the stop loss so that the user don't give away all the notional profit the strategy had made. For which the user uses the other 2 settings. The user can set it up to increase the TSL by xxx amount when the profit increases by yyy. So, for example, the user may activate the TSL at 3000 profit and then choose to increase it by 1000 with every 1000 increase in profit.

So when the profit touches 4000, the TSL will be at 1000 and at 5000 profit it will be at 2000; now if the profit drops to 2000, the strategy will exit for all positions. TSL can only be setup at strategy level and not at a set level. If the user wishes to set it up at a set level, the user will have to use the one or more own keywords and one or more conditions to make the strategy work.

In such embodiment, the method of rollover expiry (as shown in FIG. 4) may work in the below described manner: If there are any positions which may be expiring today, the trading strategy will check for this setting and if found to be true at the designated time set by the user, the framework will square off the leg and take the same leg for the next expiry automatically.

In such another embodiment, the method for overnight protection (as shown in FIG. 3) 250 may work as described below: All the legs assigned in each set under this block will get taken 15 minutes before the exchange closes and they will be reversed the next working day immediately when the market opens. This allows the user to take hedges to a short option positions to protect the user's strategy from black swan events without worrying about adding and removing these positions through conditions.

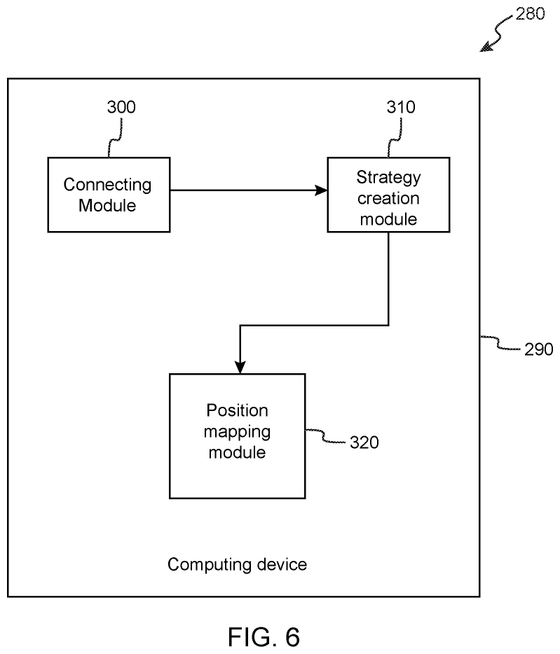

FIG. 6 is a block diagram of a system 280 to create a trading strategy in accordance with an embodiment of the present disclosure. The system 280 includes a computing device 290 in communication with a communicating network. The computing device 290 includes a connecting module 300 configured to connect one or more databases, wherein the one or more databases is associated with corresponding multiple exchanges. The system 280 is associated with an automated trading system for financial markets accessible on an internet or as a stand-alone or embedded software. An internet website is connected to the internet through a communication medium with prospective users or traders through their computer. The user may interact with the Automated Trading framework to buy or sell positions such as foreign currency, stocks, mutual funds, or the like. The Automated Trading framework may be connected to the one or more databases, associated with real time foreign currency exchange rates. The Automated Trading framework may also be connected to a financial market dealer or broker. The dealer may also obtain and make available real-time data, such as market, financial, or exchange rate data, to the one or more databases associate with the automated trading framework. Further, one or more financial institutions may be in communication with the Automated Trading framework for retrieving real time financial market data, user account information, and for processing monetary, financial or trade related transactions.

The computing device 290 also includes a strategy creation module 310 operatively coupled to the connecting module 300. The strategy creation module 310 is configured to enable a user to select one or more keywords from a plurality of keywords by using a point and click option. The strategy creation module 310 is also configured to set up one or more conditions from a plurality of pre-defined conditions corresponding to one or more selected keywords using the point and click option. The strategy creation module 310 is further configured to set up one or more parameters associated with the corresponding one or more conditions based on the one or more selected keywords using the point and click option. In one specific embodiment, the trading strategy may correspond to algorithmic strategies.

Furthermore, the computing device 290 includes a position mapping module 320 operatively coupled to the strategy creation module 310. The positioning mapping module 320 is configured to position the one or more conditions to corresponding one or more legs to create a positioning map using a positioning technique, wherein the positioning map is representative of the trading strategy. In one embodiment, the position map may be created on a web-based strategy building platform.

In one exemplary embodiment, the computing device 290 may further include a monitoring module operatively coupled to the position mapping module 320. The monitoring module may be configured to monitor the trading strategy upon deploying on a user device continuously in real-time. In such embodiment, the trading strategy is deployed on one of a paper trading platform or an on-going live platform associated with the user device.

In another exemplary embodiment, the computing device 290 may further include an analysis module operatively coupled to the position mapping module. The analysis module is configured to multiply the one or more legs into corresponding one or more tranches. In yet another exemplary embodiment, the computing device 290 may further include a notification module operatively coupled to the position mapping module. The notification module is configured to generate a notification in real time by implementing the trading strategy on a trading platform upon monitoring one or more data associated with the corresponding one or more parameters. In such embodiment, the notification may be associated to events on the trading platform in real-time.

In yet another exemplary embodiment, the computing device 290 may include a testing module operatively coupled to the position mapping module. The testing module is configured to enable the user to simulate a created trading strategy. The testing module is also configured to enable the user to modify the created trading strategy based on a simulated result. In yet another embodiment, the computing device may further include a reporting module operatively coupled to the position mapping module. The reporting module is configured to apply a scenario analysis on the trading platform using one or more scenario analysis tools.

In one preferred embodiment, the system 280 may further include a storage device operatively coupled to the computing device. The storage device may be configured to store one or more trading strategy created by the user.

Various embodiments of the present disclosure enable the system to create a web based multi asset, multi-currency, multi exchange trading strategy using point and click to create conditions and positions which form the building blocks of the system. Once created, the same can be listed on the marketplace where people can subscribe them and in turn take those trades in their own brokerage accounts with multiple position mapping to those conditions thus allowing to build for complex algo strategies with ease. Thereby making the system user friendly, more reliable and less time consuming in creating the trading strategy.

In addition, the system enables the user to create the trading strategy without coding which eases the work of the user. also, the system allow the strategy to be listed on a marketplace upon creation.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. A method for creating a trading strategy comprising:
connecting one or more databases associated with corresponding multiple exchanges;
enabling a user to create a strategy comprising:
selecting one or more keywords from a plurality of keywords by using a point and click option;
setting up one or more conditions from a plurality of pre-defined conditions corresponding to one or more selected keywords using the point and click option; and
setting up one or more parameters associated with the corresponding one or more conditions based on the one or more selected keywords using the point and click option; and
positioning the one or more conditions to corresponding one or more legs for creating a positioning map using a positioning technique, wherein the positioning map is representative of the trading strategy.

2. The method of claim 1, wherein creating the positioning map comprises creating the positioning map on a web-based strategy building platform.

3. The method of claim 2, wherein the web-based strategy building platform comprises a centralised framework.

4. The method of claim 1, wherein the trading strategy corresponds to algorithmic strategies.

5. The method of claim 1, further comprising monitoring the trading strategy upon deploying on a user device continuously in real-time.

6. The method of claim 5, wherein deploying the trading strategy on the user device comprises deploying the trading strategy on one of a paper trading platform or an on-going live platform associated with the user device.

7. The method of claim 1, further comprising multiplying the one or more legs into corresponding one or more tranches.

8. The method of claim 1, further comprising generating a notification in real time by implementing the trading strategy on a trading platform upon monitoring one or more data associated with the corresponding one or more parameters, wherein the notification is associated to events on the trading platform in real-time.

9. A system to create a trading strategy comprising:
a computing device in communication with a communicating network, wherein the computing device comprises:
a connecting module configured to connect one or more databases, wherein the one or more databases is associated with corresponding multiple exchanges;
a strategy creation module operatively coupled to the connecting module, wherein the strategy creation module is configured to:
enable a user to select one or more keywords from a plurality of keywords by using a point and click option;
set up one or more conditions from a plurality of pre-defined conditions corresponding to one or more selected keywords using the point and click option; and
set up one or more parameters associated with the corresponding one or more conditions based on the one or more selected keywords using the point and click option; and
a position mapping module operatively coupled to the strategy creation module, and configured to position the one or more conditions to corresponding one or more legs to create a positioning map using a positioning technique, wherein the positioning map is representative of the trading strategy.

10. The system as claimed in claim 9, wherein the position map is created on a web-based strategy building platform.

11. The system as claimed in claim 9, wherein the trading strategy corresponds to algorithmic strategies.

12. The system as claimed in claim 9, wherein the computing device further comprises a monitoring module operatively coupled to the position mapping module, wherein the monitoring module is configured to monitor the trading strategy upon deploying on a user device continuously in real-time.

13. The system as claimed in claim 12, wherein the trading strategy is deployed on one of a paper trading platform or an on-going live platform associated with the user device.

14. The system as claimed in claim 9, wherein the computing device further comprises an analysis module operatively coupled to the position mapping module, wherein the analysis module is configured to multiply the one or more legs into corresponding one or more tranches.

15. The system as claimed in claim 9, wherein the computing device further comprises a notification module operatively coupled to the position mapping module, wherein the notification module is configured to generate a notification in real time by implementing the trading strategy on a trading platform upon monitoring one or more data associated with the corresponding one or more parameters, wherein the notification is associated to events on the trading platform in real-time.

16. The system as claimed in claim 9, wherein the computing device further comprises a testing module operatively coupled to the position mapping module, wherein the testing module is configured to:
enable the user to simulate a created trading strategy;
enable the user to modify the created trading strategy based on a simulated result.

17. The system as claimed in claim 9, wherein the computing device further comprises a reporting module operatively coupled to the position mapping module, wherein the reporting module is configured to apply a scenario analysis on the trading platform using one or more scenario analysis tools.

18. The system as claimed in claim 9, further comprises a storage device operatively coupled to the computing device, wherein the storage device is configured to store one or more trading strategy created by the user.
